(19) United States
(12) Patent Application Publication
(10) Pub. No.: US 2021/0160467 A1
(43) Pub. Date: May 27, 2021

(54) COLOR CORRECTION METHOD AND ELECTRONIC DEVICE

(71) Applicant: Acer Incorporated, New Taipei City (TW)

(72) Inventors: Tzu-Chieh Lin, New Taipei City (TW); Wei-Kuo Shih, New Taipei City (TW)

(73) Assignee: Acer Incorporated, New Taipei City (TW)

(21) Appl. No.: 16/726,104

(22) Filed: Dec. 23, 2019

(30) Foreign Application Priority Data
Nov. 21, 2019 (TW) 108142299

(51) Int. Cl. H04N 9/31; G06T 11/00; G06T 7/90; G02B 27/01

(52) U.S. Cl. CPC H04N 9/3182; G02B 27/0172; G06T 7/90; G06T 11/001

(57) ABSTRACT

A color correction method and an electronic device are provided. The method includes: obtaining a first image displayed by a first display and a second image displayed by a second display; adjusting a color of the first image to a first color; adjusting a color of the second image to a second color; selecting the first color as a second target value; obtaining a third image displayed by the second display according to color adjustment information; adjusting a color of the third image to be close to the second target value; and displaying, by a head mounted display, according to the color adjustment information obtained by the aforementioned adjustment process.

### CROSS-REFERENCE TO RELATED APPLICATION

This application claims the priority benefit of Taiwan application no. 108142299, filed on Nov. 21, 2019. The entirety of the above-mentioned patent application is hereby incorporated by reference herein and made a part of this specification.

### TECHNICAL FIELD

The invention relates to a color correction method and an electronic device, and more particularly, to a color correction method and an electronic device for a head mounted display.

### BACKGROUND

At present, most general head mounted display (HMD) devices have a display corresponding to the left eye (a.k.a. a left eye display) and a display corresponding to the right eye (a.k.a. as a right eye display). There may be a color imbalance between the two displays. For example, the left eye display may be bluer than a right eye display. To overcome this problem, the general method is to consider both the left eye display and the right eye display at the same time, and regard each of pictures displayed by the two displays as an individual picture for color correction. However, in order to solve a picture synchronization problem for the two displays, the head mounted display normally controls a display card (e.g., a GPU) to consider the pictures of the left eye display and the right eye display as one single picture. Consequently, if a color correction mechanism currently provided by the display card is used to adjust colors of the displays, it may not be possible to independently control the color of an image displayed by one of the displays (i.e., only the left eye display or only the right eye display).

### SUMMARY

The invention proposes a color correction method and an electronic device capable of separately conducting a color adjustment process on each region in the picture belonging to a left eye image or a right eye image and correcting the problem of the color balance with images for both eyes taken into consideration, so as to achieve the best display effect of the head mounted display.

The invention proposes a color correction method for correcting a first display and a second display of a head mounted display. The method includes: obtaining a first image displayed by the first display and a second image displayed by the second display; adjusting a color of the first image to a first color, and recording first color adjustment information for adjusting the color of the first image to the first color; adjusting a color of the second image to a second color, and recording second color adjustment information for adjusting the color of the second image to the second color; selecting the first color as a second target value; obtaining a third image displayed by the second display according to the second color adjustment information; adjusting a color of the third image to be close to the second target value, and recording third color adjustment information for adjusting the color of the third image to be close to the second target value; and displaying, by the head mounted display, according to the first color adjustment information, the second color adjustment information and the third color adjustment information.

The invention proposes an electronic device for correcting a first display and a second display of a head mounted display. The electronic device includes an input/output circuit and a processor. The processor is coupled to the input/output circuit. The input/output circuit obtains a first image displayed by the first display and a second image displayed by the second display. The processor adjusts a color of the first image to a first color, and records first color adjustment information for adjusting the color of the first image to the first color. The processor adjusts a color of the second image to a second color, and records second color adjustment information for adjusting the color of the second image to the second color. The processor selects the first color as a second target value. The input/output circuit obtains a third image displayed by the second display according to the second color adjustment information. The processor adjusts a color of the third image to be close to the second target value, and records third color adjustment information for adjusting the color of the third image to be close to the second target value. The input/output circuit outputs the first color adjustment information, the second color adjustment information and the third color adjustment information so as to display, by the head mounted display, according to the first color adjustment information, the second color adjustment information and the third color adjustment information.

Based on the above, the color correction method and the electronic device of the invention can change colors of image content. For regions in the picture that belong to the left-eye image or the right-eye image, the color adjustment process is performed individually. In addition, the color correction method of the invention also corrects the problem of the color balance of images for both eyes to achieve the best display effect of the head mounted display.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an electronic device illustrated according to an embodiment of the invention.

FIG. 2 is a flowchart of a color correction method illustrated according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

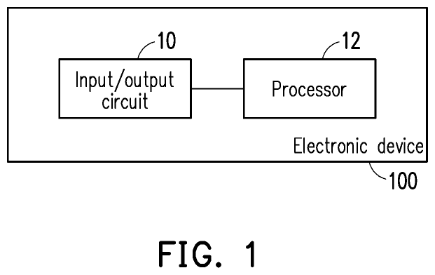

FIG. 1 is a schematic diagram of an electronic device illustrated according to an embodiment of the invention.

Referring to FIG. 1, an electronic device 100 includes an input/output circuit 10 and a processor 12.

The input/output circuit 10 is, for example, an input interface or circuit for obtaining related data from outside the electronic device 100 or from other sources. In addition, the input/output circuit 10 may also transmit data generated by the electronic device 100 to an output interface or circuit of the other electronic device, which is not particularly limited herein.

The processor 12 may be a central processing unit (CPU) or other programmable devices for general purpose or special purpose such as a microprocessor and a digital signal processor (DSP), a programmable controller, an application specific integrated circuit (ASIC) or other similar elements or a combination of above-mentioned elements.

The electronic device 100 may further include a storage circuit (not illustrated). The memory circuit may be a fixed or a movable element in any possible forms including a random access memory (RAM), a read-only memory (ROM), a flash memory or other similar elements, or a combination of the above-mentioned elements.

In this exemplary embodiment, the storage circuit of the electronic device 100 is stored with a plurality of program code segments. The code segments may be executed by the processor after being installed. For example, the memory circuit is stored with a plurality of modules. Various operations of the electronic device 100 may be executed by those modules, where each of the modules is composed of one or more of the program code segments. However, the invention is not limited in this regard. Each operation of the electronic device 100 may also be implemented in other hardware manners.

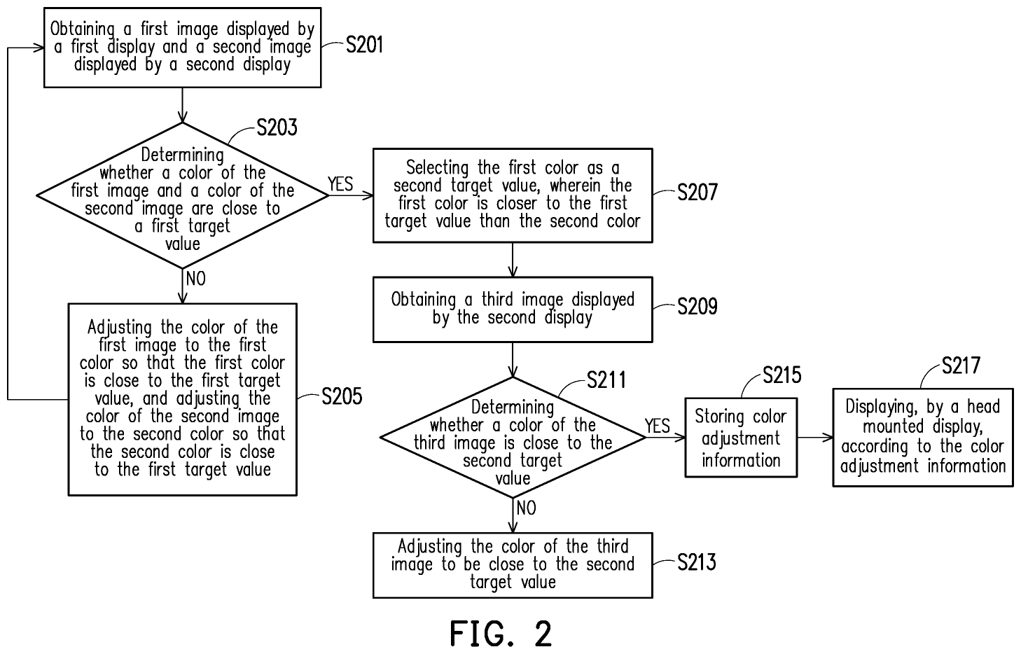

FIG. 2 is a flowchart of a color correction method illustrated according to an embodiment of the invention.

Referring to FIG. 1 and FIG. 2 together, the input/output circuit 10 obtains a first image displayed by a display (a.k.a. a first display) of a head-mounted device and a second image displayed by another display (a.k.a. a second display) (step S201). For example, to-be-corrected images displayed by the two displays of the head-mounted device may be obtained by a color analyzer, and then the obtained images may be received by the input/output circuit 10.

It should be noted that in this embodiment, the first display is the left eye display and the second display is the right eye display. However, the invention is not limited to the above. In other embodiments, the first display may be the right eye display and the second display may be the left eye display. In the following example, the first display is the left eye display and the second display is the right eye display.

Next, the processor determines whether a color of the first image and a color of the second image are close to a first target value (step S203).

More specifically, when determining whether a color (referred to as a current color hereinafter) is close to another color (referred to as a reference color hereinafter), the processor 12 determines whether a target color is between a first value and a second value. The first value is the reference color plus an offset, and the second value is the reference color minus the offset. When the target color is between the first value and the second value, the processor 12 determines that the current color is close to the reference color. In contrast, when the target color is not between the first value and the second value, the processor 12 determines that the current color is not close to the reference color.

For instance, the easier way is to calculate a difference between a color point (the coordinates (x, y) of the CIE color space) and another color point. Referring to Equation (1) and Equation (2), x_{Color1} and y_{Color1} respectively represent x-coordinate and y-coordinate of a color point of the reference color; x_{Color2} and y_{Color2} respectively represent x-coordinate and y-coordinate of a color point of the current color; errₓ is an offset of x-coordinate (i.e., an error tolerance); and err_{y} is an offset of y-coordinate (i.e., an error tolerance). When x_{Color2} satisfies Equation (1) and y_{Color2} satisfies Equation (2), the processor 12 can determine that the current color and the reference color are close. If one of Equation (1) and Equation (2) does not hold, it is considered that the colors are not close.

x_{Color1}errₓ≤x_{Color2}≤x_{Color1}+errₓ Equation (1)

y_{Color1}−err_{y}≤y_{Color2}≤y_{Color1}+err_{y} Equation (1)

It should be noted that the invention is not used to limit a value of the first target value.

When the current color is not close to the reference color, the processor 12 adjusts the color of the first image to the first color so that the first color is close to the first target value, and adjusts the color of the second image to the second color so that the second color is close to the first target value (step S205). Then, the processor 12 executes steps S201 and S203 again. That is to say, the processor 12 adjusts the color of the left eye image and the color of the right eye image so that the color of the left eye image and the color of the right eye image are both close to the first target value. It should be noted that, although the first color and the second color are both close to the first target value, the first color and the second color may be different from each another. In addition, the processor 12 further records first color adjustment information for adjusting the color of the first image to the first color, and records second color adjustment information for adjusting the color of the second image to the second color.

Then, the processor 12 selects the first color as a second target value (step S207). In particular, in this embodiment, the first color is closer to the first target value than the second color.

Next, the input/output circuit 10 obtains a third image displayed by the second display according to the second color adjustment information (step S209), and determines whether a color of the third image is close to the second target value described above (step S211). The method of determining whether two colors are close to each other has been detailed above, and is not repeated herein.

When the color of the third image is not close to the second target value, the processor 12 adjusts the color of the third image to be close to the second target value (step S213). Then, the processor 12 executes steps S209 and S211 again. In addition, the processor 12 further records third color adjustment information for adjusting the color of the third image to be close to the second target value.

When the color of the third image is close to the second target value, the processor 12 stores the color adjustment information (e.g., the first, the second and the third color adjustment information described above) (step S215). Lastly, the head mounted display can display according to the first color adjustment information, the second color adjustment information and the third color adjustment information (step S217).

That is to say, steps S201 to S205 are to respectively adjust the colors of the two displays to be close a target value of one specific target color. In steps S209 to S213, the color of one specific display is used as a standard value, and the color of the other display is adjusted to be close to the target value so that the two colors are closer to each other. In this way, with both complexity and time of the adjustment taken into consideration, the displays can display pictures that match the target color while taking into account the color balance between the left and right eye images when displaying an application or a game program containing shader content.

In summary, the color correction method and the electronic device of the invention can change colors of image content. For regions in the picture that belong to the left-eye image or the right-eye image, the color adjustment process is performed individually. In addition, the color correction method of the invention also corrects the problem of the color balance of images for both eyes to achieve the best display effect of the head mounted display.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A color correction method for correcting a first display and a second display of a head mounted display, the method comprising:
obtaining a first image displayed by the first display and a second image displayed by the second display;
adjusting a color of the first image to a first color, and recording first color adjustment information for adjusting the color of the first image to the first color;
adjusting a color of the second image to a second color, and recording second color adjustment information for adjusting the color of the second image to the second color;
selecting the first color as a second target value;
obtaining a third image displayed by the second display according to the second color adjustment information;
adjusting a color of the third image to be close to the second target value, and recording third color adjustment information for adjusting the color of the third image to be close to the second target value; and
displaying, by the head mounted display, according to the first color adjustment information, the second color adjustment information and the third color adjustment information.

2. The color correction method according to claim 1, wherein the step of adjusting the color of the first image to the first color comprises:
adjusting the color of the first image to the first color so that the first color is close to a first target value,
wherein the step of adjusting the color of the second image to the second color comprises:
adjusting the color of the second image to the second color so that the second color is close to the first target value.

3. The color correction method according to claim 1, wherein the first color is closer to the first target value than the second color.

4. The color correction method according to claim 1, further comprises:
obtaining the first image, the second image and the third image by a color analyzer.

5. The color correction method according to claim 1, wherein a step of determining whether a current color is close to a reference color comprises:
determining whether a target color is between a first value and a second value, wherein the first value is the reference color plus an offset and the second value is the reference color minus the offset;
when the target color is between the first value and the second value, determining that the current color is close to the reference color; and
when the target color is not between the first value and the second value, determining that the current color is not close to the reference color.

6. An electronic device for correcting a first display and a second display of a head mounted display, the electronic device comprising:
an input/output circuit; and
a processor, coupled to the input/output circuit, wherein
the input/output circuit obtains a first image displayed by the first display and a second image displayed by the second display,
the processor adjusts a color of the first image to a first color, and records first color adjustment information for adjusting the color of the first image to the first color,
the processor adjusts a color of the second image to a second color, and records second color adjustment information for adjusting the color of the second image to the second color,
the processor selects the first color as a second target value,
the input/output circuit obtains a third image displayed by the second display according to the second color adjustment information,
the processor adjusts a color of the third image to be close to the second target value, and records third color adjustment information for adjusting the color of the third image to be close to the second target value, and
the input/output circuit outputs the first color adjustment information, the second color adjustment information and the third color adjustment information so as to display, by the head mounted display, according to the first color adjustment information, the second color adjustment information and the third color adjustment information.

7. The electronic device according to claim 6, wherein in the operation of adjusting the color of the first image to the first color,
the processor adjusts the color of the first image to the first color so that the first color is close to a first target value,
wherein in the operation of adjusting the color of the second image to the second color,
the processor adjusts the color of the second image to the second color so that the second color is close to the first target value.

8. The electronic device according to claim 6, wherein the first color is closer to the first target value than the second color.

9. The electronic device according to claim 6, wherein
the first image, the second image and the third image are obtained by a color analyzer.

10. The electronic device according to claim 6, wherein in an operation of determining whether a current color is close to a reference color,
the processor determines whether a target color is between a first value and a second value, wherein the first value is the reference color plus an offset and the second value is the reference color minus the offset,
when the target color is between the first value and the second value, the processor determines that the current color is close to the reference color, and
when the target color is not between the first value and the second value, the processor determines that the current color is not close to the reference color.
